(19) United States
(12) Patent Application Publication
(10) Pub. No.: US 2011/0151158 A1
(43) Pub. Date: Jun. 23, 2011

(54) Method of making a food casing

(76) Inventors: Alan D. Stall, Naperville, IL (US); Carl Frauenpreis, Wallingford, CT (US); Vladimier A. Sinani, Branford, CT (US); Tom L. Hicks, Port Jefferson, NY (US); Tatyana Y. Samoylova, Lowell, MA (US)

(21) Appl. No.: 12/927,798

(22) Filed: Nov. 24, 2010

Related U.S. Application Data
(63) Continuation-in-part of application No. PCT/US10/36176, filed on May 26, 2010.
(60) Provisional application No. 61/330,367, filed on May 2, 2010.
(60) Provisional application No. 61/180,964, filed on May 26, 2009.

(51) Int. Cl. A22C 13/00; B29C 47/20

(52) U.S. Cl. 428/34.8; 264/209.1

(57) ABSTRACT

In a method of making a food casing a mixture is extruded to form a seamless tube. The mixture comprises at least 10% of cellulose fiber and at least 50% of nylon-6 content. The nylon-6 content has a weighted average viscosity number of at least 155 ml/g and at most 230 ml/g. The seamless tube is oriented by at least 10% in the machine direction with at most 0% orientation in the transverse direction to form an oriented seamless tube.

This application is a continuation-in-part of International Patent Application No. PCT/US2010/036176 filed May 26, 2010, which claims the benefit of U.S. Provisional Patent Applications Ser. No. 61/180,964 filed May 26, 2009 and 61/330,367 filed May 2, 2010. Each of these three applications is incorporated herein in its entirety by reference.

The presently disclosed subject matter relates generally to methods of making food casings and the resulting food casings.

### BACKGROUND

Regenerated-cellulose food casings that are extruded using a wet chemical regeneration process are used in the production of stuffed food products such as sausages. These types of casings are highly permeable membranes, allowing high amounts of smoke and water transfer. However, casings produced using such methods generate chemicals and other by-products that may negatively affect the environment.

### SUMMARY

In one embodiment, a method of making a food casing comprises the following steps. A mixture is extruded to form a seamless tube. The mixture comprises (i) at least 10% of cellulose fiber based on the weight of the mixture; and (ii) at least 50% of nylon-6 content based on the weight of the mixture, wherein the nylon-6 content has a weighted average viscosity number of at least 155 ml/g and at most 230 ml/g. The seamless tube is oriented by at least 10% in the machine direction with at most 0% orientation in the transverse direction to form an oriented seamless tube.

In another embodiment, a method of making a food casing comprises the following steps. A mixture is cast extruded to form a cast film. The mixture comprises (i) at least 10% of cellulose fiber based on the weight of the mixture and (ii) at least 50% of nylon-6 content based on the weight of the mixture, wherein the nylon-6 content has a weighted average viscosity number of at least 155 ml/g and at most 230 ml/g. The cast film is oriented by at least 10% in at least one direction to form an oriented film. The oriented film is seamed longitudinally to form an oriented seamed tube.

The features of various embodiments, and the manner of attaining them, will become more apparent and the embodiments will be better understood by reference to the following description of the disclosed embodiments.

### DETAILED DESCRIPTION

The embodiments discussed below are not intended to be exhaustive or limit the invention to the precise forms disclosed in the following detailed description. Rather, the embodiments are chosen and described so that others skilled in the art may utilize their teachings.

### Extruding a Mixture

In various embodiments, a mixture is extruded to form a seamless tube or a cast film, which are subsequently oriented. The mixture comprises nylon-6 content and cellulose fiber.

### Nylon-6 Content of the Mixture

The mixture may comprise any of at least 50, 60, 70, 80, and 85% of nylon-6 content, based on the weight of the mixture. The mixture may comprise any of at most 55, 60, 70, 80, and 90% of nylon-6 content, based on the weight of the mixture. “Nylon-6 content” is the total combined amount of the one or more nylon-6 grades in the mixture. The nylon-6 content may be provided by one grade of nylon-6. Alternatively, the nylon-6 content may be provided by two or more differing nylon-6 grades having differing physical properties such as molecular weight or viscosity. The nylon-6 content may be provided by any of two, three, three or more, four, or four or more differing nylon-6 grades.

The nylon-6 content of the mixture may have a weighted average viscosity number of at least any of the following: 155, 160, 165, 170, and 175 ml/g; and/or at most any of the following: 230, 220, 215, 210, 200, 190, 185, and 180 ml/g. For example, the weighted average viscosity number may be at least 155 and at most 230. All references to the “weighted average viscosity number” of the nylon-6 content are calculated by the formula:

Σ(VNᵢ×wtᵢ) for i ranging from 1 to n

where:

“n” is the total number of different nylon-6 grades making up the total nylon-6 content;

“NVᵢ” is the viscosity number for nylon-6 grade “i” (ml/g); and

“wtᵢ” is the weight fraction of nylon-6 grade “i” in the total nylon-6 content.

The nylon-6 content weighted average viscosity number of a mixture having just one nylon-6 grade is the viscosity number of that nylon-6 grade. All references to the viscosity number of a nylon-6 grade herein are according to ISO 307:2007 and determined at 25° C. by 0.5% [m/v] of the nylon-6 grade in 96% [m/m] sulfuric acid.

The mixture may comprise at least any of the following amounts of one or more nylon-6 grades having viscosity numbers of less than 165 ml/g: 45, 50, 55, 60, 65, 70, 75, 80, and 85%, based on the weight of the mixture. The mixture may comprise at least any of the following amounts of one or more nylon-6 grades having viscosity numbers of at least 165 ml/g: 5, 10, 15, 20, 25, 30, 35, 40, and 45%, based on the weight of the mixture. For example, the mixture may comprise at least any of the following amounts of a first nylon-6 having a viscosity number of less than 165 ml/g: 45, 50, 55, 60, 65, 70, 75, 80, and 85%, based on the weight of the mixture. The mixture may comprise at least any of the following amounts of a second nylon-6 having a viscosity number of at least 165 ml/g: 5, 10, 15, 20, 25, 30, 35, 40, and 45%, based on the weight of the mixture.

Some useful nylon-6 grades include those available from BASF Corporation under the Ultramid trade name, for example, Ultramid B50, Ultramid B40, Ultramid B-36, Ultramid B33, Ultramid B32, and Ultramid B27, having manufacture reported viscosity numbers of about 319, 250, 218, 195, 184, and 150 ml/g, respectively.

Nylon-6 generally has a melting point of about 220° C. All references to melting point of a polymer, a resin, or a film layer in this application refer to the melting peak temperature of the dominant melting phase of the polymer, resin, or layer as determined by differential scanning calorimetry according to ASTM D-3418.

The mixture may be substantially free of any thermoplastic polymer other than polyamide. The mixture may be substantially free of polyamide other than the nylon-6 content. Alternatively, the mixture may comprise one or more additional polyamides. For example, the mixture may comprise one or more additional polyamides selected from nylon-6/6,6, nylon-11, nylon-12, and nylon-6,I/6,T, in at least, and/or at most, any of the following amounts, based on the weight of the mixture: 40, 30, 20, 10, 5, 2, and 1%. The mixture may be substantially free of any of these additional polyamides. For example, the mixture may be substantially free of nylon-6/6,6. “Substantially free” of an item means the lack of that item except for a minor amount that does not appreciably affect the performance properties of the mixture in its expected use. Thus, for example, drinking water may be substantially free from table salt, yet still have a minor amount of dissolved NaCl that is not sufficient to affect the taste of the water.

### Cellulose Fibers

The mixture may comprise at least any of the following amounts of cellulose fiber, based on the weight of the mixture: 10, 12, 15, 18, 20, 22, 25, 28, 30, 32, 35, 38, 40, 42, and 45%. The mixture may comprise at most any of the following amount of cellulose fiber, based on the weight of the mixture: 12, 15, 18, 20, 22, 25, 28, 30, 32, 35, 38, 40, 42, 45, and 50%.

The cellulose fiber may have an average fiber length of at least, and/or at most, any of the following: 10, 20, 30, 50, 75, 90, 100, 125, 150, 175, 200, 225, and 250 microns. The cellulose fiber may have an average fiber diameter of at least, and/or at most, any of the following: 0.5, 1, 3, 5, 7, and 10 microns. The cellulose fiber may have a composite fiber thickness of at least, and/or at most, any of the following: 5, 10, 15, 20, and 25 microns.

Exemplary cellulose fiber includes cotton (such as cotton linters), pulp, regenerated cellulose, sulfite, kraft, or sulfate pulps, dissolving pulp, refined cellulose, caustic soda treated pulp, and fibers derived from high-purity alpha wood pulp, softwood and/or hardwood pulps and pulp originated from other plants (e.g., hemp, flax). Exemplary cellulose fiber is described, for example, in U.S. Pat. No. 6,270,883 to Sears et al, which is incorporated herein in its entirety by reference. Cellulose fibers are not water-soluble and absorb water, for example, by up to 100% of the cellulose fiber weight in water. In the presence of oxygen, cellulose begins to decompose at about 180° C., as evidenced by browning resulting from charring or scorching; and at about 220° C., cellulose burns or decomposes extensively.

### Additives

The mixture may include one or more additives, such as processing aids, lubricants, antistatic additives, flow enhancers, stabilizers, pigments, nucleating agents, and functional additives. For example, the mixture may include one or more mold release agents, for example, one or more of mold-release stearates, such as calcium stearate, in an amount of at least any of at least, and/or at most 0.01, 0.1, 0.5, and 1 wt.%, based on the weight of the mixture. It is believed that such mold release agents may at least partially coat the cellulose fibers, and subsequently act as a release agent on the surface of the cellulose fibers, to help create microvoids around the cellulose fibers during orientation of other processing, as described herein.

### Water-Soluble Polymers

The mixture may comprise less than 1%, based on the weight of the mixture, of water-soluble compound selected from one or more of polyvinyl alcohol (PVOH), poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide. Such water-soluble compounds are described in U.S. Patent Application Publication 2006/0202397 A1 to Stalberg, which is incorporated herein in its entirety by reference. The mixture may be substantially free of a water-soluble compound selected from one or more of PVOH, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide, such as those described in the Stalberg publication.

The mixture may comprise less than 1%, based on the weight of the mixture, of water-soluble compounds and/or water-soluble synthetic polymers. The mixture may be substantially free of water-soluble compounds and/or water-soluble synthetic polymers and/or compounds miscible in water. In this context, “water-soluble” means that the compound has a solubility of at least 1 gram per 100 mL of 25° C. water. Exemplary water-soluble compounds, in addition to those listed above, include glycerin, propylene glycol, polyox (polyethylene oxide), poly(lactic acid), polyethylene glycols, cellulose ethers, sugars, starches, and certain salts.

The mixture may comprise less than 1%, based on the weight of the mixture, of compounds (other than water) that transition to a liquid state below 120° C. The mixture may be substantially free of compounds (other than water) that transition to a liquid state below 120° C.

### Extruding the Mixture

The mixture is extruded to form a seamless tube or a cast film. The mixture may be formed before the extrusion step or the mixture may be formed during the extrusion step, for example by feeding components or a combination of some components of the mixture at various ports along the barrel of an extruder. Thus, the mixture may be formed by adding one or more components of the mixture separately to an extruder, to mix the components while extruding the mixture. Some of the components may be pre-mixed before addition to the extruder. If the mixture is formed before the extrusion step, the mixture may, for example, be extruded separately, and optionally pelletized, in a first mixing/extrusion step to form the mixture before the mixture is fed to the extruder that forms the seamless tube or cast film.

The mixture may be formed using any of internal batch mixer, compound extrusion, co-kneader, twin-screw extrusion (co- or counter-rotating), and single-screw extrusion. The mixture may be formed using an extensional flow mixer or an extruder comprising an extensional flow mixing section to mix the components. Alternatively, the mixture may be formed without using an extensional flow mixing section.

In some embodiments of the presently disclosed subject matter, the mixture is extruded through a die to form a seamless tube, for example by utilizing blown film extrusion or by utilizing annular cast film extrusion. Such extruders may be single-screw, or twin screw (co- or counter-rotating). Exemplary extruders include the Thermo-Haake Polylab RC400P extruder with a Rheomex 252P Single Screw attachment and Coperion ZSK30 12 barrel extruder.

As is known in the art, the extruder may have a plurality of sections and zones, such as a feed zone, melting zone, and metering zone (melt conveying zone). The extruder may be vented such that it is multi-staged (e.g., two-stage) with a decompression zone and metering zone. A section or zone may be ported, for example, to permit venting and/or provide a location or feeder through which to add components of the mixture, such as the cellulose fibers. Thus, components of the mixture may be added in one or more places along the melt stream of the extruder.

The extruder may comprise a mixer as a section integral within the extruder barrel and, for example, proximate the outlet of the extruder. As described above, the extruder may comprise an extensional flow mixing section or may be substantially free of an extensional flow mixing or extrusion section. Exemplary extensional flow mixers are disclosed in U.S. Pat. Nos. 5,451,106 and 6,550,956 to Utracki et al., U.S. Pat. No. 6,299,342 to Eggen et al., U.S. Patent Application Publication 2009/0230223 published Sep. 17, 2009 (Ser. No. 12/399,010) to Stall et al. (the “Tek-Mix Application”), and International Patent Application No. PCT/US2010/036176 filed May 26, 2010, each of which is incorporated herein in its entirety by reference.

### Orienting

The seamless tube may be oriented (stretched) in the machine direction by at least any of the following percentage amounts: 10, 15, 20, 25, 30, 40, 50, 70, 100, 125, 150, 175, and 200%. A tube or film having an initial length in the machine direction of 10 inches that is oriented to a stretched length in the machine direction of 11 inches has been oriented by 10% (i.e., ((11−10)/10)×100). The seamless tube may be oriented in the transverse direction by at most 0%.

The flat cast film may be oriented in at least one direction by at least any of the following percentage amounts: 10, 15, 20, 25, 30, 40, 50, 70, 100, 125, 150, 175, and 200%. The flat cast film may be oriented in the machine direction and/or the transverse direction independently by at least any of the following percentage amounts: 10, 15, 20, 25, 30, 40, 50, 70, 100, 125, 150, 175, and 200%. For example, the flat cast film may be oriented in the machine direction by at least 50% and in the transverse direction by at least 10%. The flat cast film may be oriented in only the machine direction, with at most 0% orientation in the transverse direction.

Orientation techniques are known in the art, and include blown bubble, tenterframe, and intermeshing-gear stretching. For example, orientation in the machine direction may utilize upstream and downstream stretching rolls paired with corresponding upstream and downstream nip rolls, where the corresponding pair operate at different rates of speed to stretch the film in the machine direction.

The orientation of the seamless tube or the flat cast film may take place while submerged in, or otherwise exposed to, room temperature or heated liquid water (i.e., wet stretching). In wet stretching, as the tube or film stretches, the cellulose fiber absorbs water and swells. Water may subsequently be squeezed out of the oriented structure and/or the structure air-dried to reshrink the cellulose fiber after swelling with water, which is believed to help create micropores or voids around individual cellulose fibers dispersed in the mixture. Alternatively, the orientation of the seamless tube or the flat cast film may take place in ambient air or heated air or may utilize infrared heating (i.e., dry stretching), for example, in air having ambient or enhanced humidity.

The flat cast oriented film is seamed longitudinally to form an oriented seamed tube. The longitudinal seam may be formed, for example, by any of heat sealing (e.g., hot knife, hot wire), mechanically clipping or clamping, impulse sealing, ultrasonic sealing, band sealing, radio frequency (RF) sealing, adhesive sealing, laser sealing, and solvent-based sealing.

### Physical Characteristics

Each of the oriented seamless tube and oriented seamed tube may have a wall thickness of at least, and/or at most, any of the following: 20, 30, 40, 50, 80, 100, 150, and 200 microns. Each of the seamless tube and/or flat cast films may be monolayer.

Each of the oriented seamless tube and oriented seamed tube embodiments may have an external diameter of at least, and/or at most, any of the following external diameters: 12, 15, 20, 30, 40, 50, 75, 100, 150, and 200 mm.

The extrusion and orientation of the structures, optionally together with the swelling and contraction of the cellulose fiber as it is wetted and dried, creates voids within the seamless tube and cast film, typically adjacent the cellulose fibers. Voids (i.e., internal micro-voids, micro-tears, micro-pores) are distinct from perforations, that is, holes or openings created by mechanically piercing the structure. Thus, the oriented seamless tube and oriented seamed tube flat cast film may be unperforated, yet have void content.

Any of the oriented seamless tube or oriented seamed tube may have a void content of at least, and/or at most, any of the following: 20, 25, 30, 35, and 40%. The void content (%) is determined by subtracting from 100% the ratio (%) of the apparent density to the calculated specific density. The apparent density, thickness, and area measurements are made according to ASTM D2346, ASTM D1813, and ASTM D2347, respectively, except as applied to a film rather than leather, measuring the dimensions and weight for a 7 inch length of representative film material. The calculated specific density is determined by multiplying the density of each component in the structure by its fractional weight in the structure.

The orientation step may increase the void content of the resulting oriented structure compared to the pre-oriented structure, by at least any of the following percentage points: 1, 2, 3, 5, 8, 10%. For example, the seamless tube before orientation may have a void content of at least 15%, which may be increased by at least 2 percentage points to at least 17% void content after orientation.

The drying step after wet stretching the structure may increase the void content of the resulting oriented structure compared to the pre-dried structure, by at least any of the following percentage points: 1, 2, 3, 5, 8, 10%. For example, the seamless tube before drying the cellulose fiber in the mixture may have a void content of at least 15%, which may be increased by at least 2 percentage points to at least 17% void content after drying the cellulose fiber.

### Water Transmission Rate

The oriented seamless tube and/or oriented seamed tube may have a water transmission rate (WTR) of at least 24 g/m2/hr. As used herein, WTR is with respect to an unperforated structure. The WTR test is described herein. Any of the oriented seamless tube and/or oriented seamed tube may have a WTR, for any of the recited wall thicknesses set forth herein, of at least, and/or at most, any of the following: 24, 28, 30, 35, 40, 50, 80, 100, 120, and 150 g/m2/hr. It is believed that orienting the structures enhances the WTR by enhancing permeability paths between the cellulose fiber sites and creating new voids to replace some that may have elongated or collapsed during orientation.

To determine the WTR an unperforated representative sample of the tube to be tested is obtained. The tube is closed transversely at one end by heat sealing the end closed, clamping the end closed, or by tying the end tightly into a knot. The heat sealing and/or clamping to form the seams use means sufficient to close or form the tube for the test without creating pinholes or leaks at the seam through which liquid water can escape.

The length of the tube is sufficient to have a water-wetted length of at least 20 cm. The tube is filled with water to have given height (e.g., from 20 to 30 cm) of wetted internal surface at 23° C. and the unsealed tube end is closed as discussed above with respect to closing the other end. The filled tube is then weighed and is hung in a controlled environment at 23° C. and 50% relative humidity. The tube is again weighed after a selected hang time, namely, 7 hours, 7.5 hours, or 8 hours. The tube dimensions (length of wetted surface, wall thickness, tube diameter) are determined to calculate the internal surface area of the tube. The weights of the sealed tube upon sealing, upon filling, and subsequently after the given hang time are compared to calculate the WTR for the given hang time.

The WTR is the weight of water loss (grams) after the given hang time divided by the area of original wetted internal surface of the test tube (m2) and divided by the selected amount of hang time of the test period:

WTR=(Weight of water loss, grams)/(Original wetted internal surface area, m2)/(hang time, hrs)

The WTR is determined for the selected hang time period (7, 7.5, or 8 hours) and reported in the dimensions of grams/m2/hour.

### Stretch Burst Test

The strength of a tube may be analyzed by a “stretch-burst” test. To conduct stretch-burst tests herein, samples of the tube are soaked for 10 minutes in room temperature water to simulate conditions of use for sausage casings. The tube sample is about 18 inches long, which when allowing for clamping and/or attachment to the testing apparatus, the actual tested length is about 16 inches. One end of the tube is sealed to the pressure source and the other end is sealed around a rubber plug equipped with a pressure gauge or otherwise sealed or tied off. The tube is inflated to about 1 psig to de-wrinkle the tube. Compressed air is slowly introduced so that the tube ruptures within about one minute. The diameter of the tube and the inflation pressure readings may be taken manually or otherwise determined at various inflation pressure increments. The internal inflation pressure at which the tube bursts is recorded as the “burst pressure.” Typical stretch-burst tests are also described in U.S. Statutory Invention Registration No. H1,592 and U.S. Pat. No. 5,470,519, each of which is incorporated herein in its entirety by reference.

The burst pressure of any of the oriented seamless and/or oriented seamed tubes may be at least any of the following: 4, 5, 6, 7, 8, 10, 12, and 14 psig.

### Appearance Characteristics

The structures of oriented seamless tube and/or oriented seamed tube may be transparent (at least in the non-printed regions) so that a packaged or enclosed article may be visible through the film. “Transparent” means that the film transmits incident light with negligible scattering and little absorption, enabling objects (e.g., the packaged article or print) to be seen clearly through the film under typical viewing conditions (i.e., the expected use conditions of the material).

The regular transmittance (i.e., clarity) of the structures of oriented seamless tube and/or oriented seamed tube may be at least any of the following values: 65%, 70%, 75%, 80%, 85%, and 90%, measured in accordance with ASTM D1746. All references to “regular transmittance” values in this application are by this standard.

The total luminous transmittance (i.e., total transmittance) of the structures of oriented seamless tube and/or oriented seamed tube may be at least any of the following values: 65%, 70%, 75%, 80%, 85%, and 90%, measured in accordance with ASTM D1003. All references to “total luminous transmittance” values in this application are by this standard.

### Use of the Tube

Embodiments of the oriented seamless tube and oriented seamed tube as disclosed herein may be used for meat packaging and cooking. The tubes may serve as casings for sausage and other meat products and emulsions. In such applications, pressurized foodstuffs are inserted, or stuffed, into the casing, which may expand as a result. The casing is adapted to withstand the expected stuffing pressure and retain residual strength and elasticity to withstand additional pressure, which may be encountered during further packaging, transportation, and display.

The following sentences describe various embodiments of the disclosed subject matter.
A. A method of making a food casing comprising:

extruding a mixture to form a seamless tube, the mixture comprising:
at least 10% of cellulose fiber based on the weight of the mixture; and
at least 50% of nylon-6 content based on the weight of the mixture, wherein the nylon-6 content has a weighted average viscosity number of at least 155 ml/g and at most 230 ml/g; and

orienting the seamless tube by at least 10% in the machine direction with at most 0% orientation in the transverse direction to form an oriented seamless tube.
B. The method of sentence A wherein the orienting step orients the seamless tube by at least any of 15, 20, 25, 30, 40, 50, 70, 100, 125, 150, 175, and 200% in the machine direction.
C. The method of any one of the previous sentences wherein the mixture is substantially free of any polyamide other than nylon-6.
D. The method of any one of the previous sentences wherein the orienting step provides an oriented seamless tube having a void content of at least any of 20, 25, 30, 35, and 40%.
E. The method of any one of the previous sentences wherein the orienting step increases the void content of the seamless tube by at least any of 1, 2, 3, 5, 8, 10 percentage points.
F. The method of any one of the previous sentences wherein the orienting step occurs while submerging the seamless tube under water.
G. The method of sentence F wherein the oriented seamless tube is subsequently dried to increase the void content by at least any of 1, 2, 3, 5, 8, 10 percentage points.
H. The method of any one of the previous sentences wherein the nylon-6 content has a weighted average viscosity number of at most any of the following: 230, 220, 215, 210, 200, 190, 185, and 180 ml/g.
I. The method of any one of the previous sentences wherein the nylon-6 content has a weighted average viscosity number of at least any of the following: 155, 160, 165, 170, and 175 ml/g.
J. The method of any one of the previous sentences wherein the mixture comprises:

at least any of 45, 50, 55, 60, 65, 70, 75, 80, and 85%, based on the weight of the mixture, of one or more nylon-6 grades having a viscosity number of less than 165 ml/g; and

at least any of 5, 10, 15, 20, 25, 30, 35, 40, and 45%, based on the weight of the mixture, of one or more nylon-6 grades having a viscosity number of at least 165 ml/g.
K. The method of any one of the previous sentences wherein the mixture comprises less than 1%, by weight of the mixture, of one or more water-soluble compounds selected from polyvinyl alcohol, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide.
L. The method of any one of the previous sentences wherein the mixture is substantially free of water-soluble compounds selected from one or more water-soluble compounds selected from polyvinyl alcohol, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide.
M. The method of any one of the previous sentences wherein the mixture comprises less than 1% water-soluble synthetic polymers, based on the weight of the mixture.
N. The method of any one of the previous sentences wherein the mixture is substantially free of water-soluble synthetic polymers.
O. The method of any one of the previous sentences wherein the oriented seamless tube has a burst pressure of at least any of the following: 4, 5, 6, 7, 8, 10, 12, and 14 psig.
P. The method of any one of the previous sentences wherein the oriented seamless tube has a water transmission rate for an 8 hour hang time of at least any of 24, 28, 30, 35, 40, 50, 80, 100, 120, and 150 g/m2/hr and/or at most any of 24, 28, 30, 35, 40, 50, 80, 100, 120, and 150 g/m2/hr.
Q. The method of any one of the previous sentences wherein the oriented seamless tube has a wall thickness of at least any of 20, 30, 40, 50, 80, 100, 150, and 200 microns.
R. The method of any one of the previous sentences wherein the oriented seamless tube is monolayer.
S. The method of any one of the previous sentences wherein the cellulose fiber has an average fiber length of at least any of 10, 20, 30, 50, 75, 90, 100, 125, 150, 175, 200, 225, and 250 microns.
T. The method of any one of the previous sentences wherein the mixture comprises at least any of 10, 12, 15, 18, 20, 22, 25, 28, 30, 32, 35, 38, 40, 42, and 45% cellulose fiber.
U. The method of any one of the previous sentences wherein the mixture comprises at least any of 50, 60, 70, 80, and 85% of nylon-6 content, based on the weight of the mixture.
V. The method of any one of the previous sentences wherein the mixture comprises at most any of 55, 60, 70, 80, and 90% of nylon-6 content, based on the weight of the mixture.
W. The method of any one of the previous sentences wherein the extruding step comprises extruding with a twin screw extruder.
X. The method of any one of the previous sentences wherein the extruding step does not use extensional flow mixing.
Y. A food casing made by the method of any one of the previous sentences.
AA. A method of making a food casing comprising:

cast extruding a mixture to form a cast film, the mixture comprising:
at least 10% of cellulose fiber based on the weight of the mixture; and
at least 50% of nylon-6 content based on the weight of the mixture, wherein the nylon-6 content has a weighted average viscosity number of at least 155 ml/g and at most 230 ml/g;

orienting the cast film by at least 10% in at least one direction to form an oriented film; and
seaming the oriented film longitudinally to form an oriented seamed tube.
BB. The method of sentence AA wherein the orienting step orients the cast film by at least any of 15, 20, 25, 30, 40, 50, 70, 100, 125, 150, 175, and 200% in a direction selected from machine direction, transverse direction, and both the machine and transverse directions.
CC. The method of any one of the previous sentences wherein the orienting step orients the cast film by at most 0% in the transverse direction.
DD. The method of any one of the previous sentences wherein the orienting step provides an oriented film having a void content of at least any of 20, 25, 30, 35, and 40%.
EE. The method of any one of the previous sentences wherein the orienting step increases the void content of the cast film by at least any of 1, 2, 3, 5, 8, 10 percentage points.
FF. The method of any one of the previous sentences wherein the orienting step occurs while submerging the cast film under water.
GG. The method of sentence FF wherein the oriented cast film is subsequently dried to increase the void content by at least any of 1, 2, 3, 5, 8, 10 percentage points.
HH. The method of any one of the previous sentences wherein the nylon-6 content has a weighted average viscosity number of at most any of the following: 230, 220, 215, 210, 200, 190, 185, and 180 ml/g.
II. The method of any one of the previous sentences wherein the nylon-6 content has a weighted average viscosity number of at least any of the following: 155, 160, 165, 170, and 175 ml/g.
JJ. The method of any one of the previous sentences wherein the mixture comprises:

at least any of 45, 50, 55, 60, 65, 70, 75, 80, and 85%, based on the weight of the mixture, of one or more nylon-6 grades having a viscosity number of less than 165 ml/g; and

at least any of 5, 10, 15, 20, 25, 30, 35, 40, and 45%, based on the weight of the mixture, of one or more nylon-6 grades having a viscosity number of at least 165 ml/g.
KK. The method of any one of the previous sentences wherein the mixture comprises less than 1%, by weight of the mixture, of one or more water-soluble compounds selected from polyvinyl alcohol, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide.
LL. The method of any one of the previous sentences wherein the mixture is substantially free of water-soluble compounds selected from one or more water-soluble compounds selected from polyvinyl alcohol, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide.
MM. The method of any one of the previous sentences wherein the mixture comprises less than 1% water-soluble synthetic polymers, based on the weight of the mixture. NN. The method of any one of the previous sentences wherein the mixture is substantially free of water-soluble synthetic polymers.

OO. The method of any one of the previous sentences wherein the oriented seamed tube has a burst pressure of at least any of the following: 4, 5, 6, 7, 8, 10, 12, and 14 psig.
PP. The method of any one of the previous sentences wherein the oriented seamed tube has a water transmission rate for an 8 hour hang time of at least any of 24, 28, 30, 35, 40, 50, 80, 100, 120, and 150 g/m2/hr and/or at most any of 24, 28, 30, 35, 40, 50, 80, 100, 120, and 150 g/m2/hr.
QQ. The method of any one of the previous sentences wherein the oriented seamed tube has a wall thickness of at least any of 20, 30, 40, 50, 80, 100, 150, and 200 microns.
RR. The method of any one of the previous sentences wherein the oriented seamed tube is monolayer.
SS. The method of any one of the previous sentences wherein the cellulose fiber has an average fiber length of at least any of 10, 20, 30, 50, 75, 90, 100, 125, 150, 175, 200, 225, and 250 microns.
TT. The method of any one of the previous sentences wherein the mixture comprises at least any of 10, 12, 15, 18, 20, 22, 25, 28, 30, 32, 35, 38, 40, 42, and 45% cellulose fiber.
UU. The method of any one of the previous sentences wherein the mixture comprises at least any of 50, 60, 70, 80, and 85% of nylon-6 content, based on the weight of the mixture.
VV. The method of any one of the previous sentences wherein the mixture comprises at most any of 55, 60, 70, 80, and 90% of nylon-6 content, based on the weight of the mixture.
WW. The method of any one of the previous sentences wherein the extruding step comprises extruding with a twin screw extruder.
XX. The method of any one of the previous sentences wherein the extruding step does not use extensional flow mixing.
YY. The method of any one of the previous sentences wherein the mixture is substantially free of any polyamide other than nylon-6.
ZZ. A food casing made by the method of any one of the previous sentences.
AAA. A method of making a food casing comprising:

extruding a mixture to form either a seamless tube or a cast film, the mixture comprising:
at least 10% of cellulose fiber based on the weight of the mixture; and
at least 50% of nylon-6 content based on the weight of the mixture, wherein the nylon-6 content has a weighted average viscosity number of at least 155 ml/g and at most 230 ml/g; and

orienting the seamless tube or the cast film, wherein:
the seamless tube is oriented by at least 10% in the machine direction with the proviso that the seamless tube is oriented by at most 0% orientation in the transverse direction; and
the cast film is oriented by at least 10% in at least one direction to form an oriented cast film which is subsequently seamed longitudinally;

thereby forming an oriented tube.
BBB. The method of sentence AAA wherein the orienting step orients the seamless tube or cast film by at least any of 15, 20, 25, 30, 40, 50, 70, 100, 125, 150, 175, and 200% in the machine direction.
CCC. The method of any one of the previous sentences wherein the mixture is substantially free of any polyamide other than nylon-6.
DDD. The method of any one of the previous sentences wherein the orienting step provides an oriented seamless tube or an oriented cast film having a void content of at least any of 20, 25, 30, 35, and 40%.
EEE. The method of any one of the previous sentences wherein the orienting step increases the void content of the seamless tube or the cast film by at least any of 1, 2, 3, 5, 8, 10 percentage points.
FFF. The method of any one of the previous sentences wherein the orienting step occurs while submerging the seamless tube or the cast film under water.
GGG. The method of sentence FFF wherein the oriented seamless tube or the oriented cast film is subsequently dried to increase the void content by at least any of 1, 2, 3, 5, 8, 10 percentage points.
HHH. The method of any one of the previous sentences wherein the nylon-6 content has a weighted average viscosity number of at most any of the following: 230, 220, 215, 210, 200, 190, 185, and 180 ml/g.
III. The method of any one of the previous sentences wherein the nylon-6 content has a weighted average viscosity number of at least any of the following: 155, 160, 165, 170, and 175 ml/g.
JJJ. The method of any one of the previous sentences wherein the mixture comprises:

at least any of 45, 50, 55, 60, 65, 70, 75, 80, and 85%, based on the weight of the mixture, of one or more nylon-6 grades having a viscosity number of less than 165 ml/g; and

at least any of 5, 10, 15, 20, 25, 30, 35, 40, and 45%, based on the weight of the mixture, of one or more nylon-6 grades having a viscosity number of at least 165 ml/g.
KKK. The method of any one of the previous sentences wherein the mixture comprises less than 1%, by weight of the mixture, of one or more water-soluble compounds selected from polyvinyl alcohol, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide.
LLL. The method of any one of the previous sentences wherein the mixture is substantially free of water-soluble compounds selected from one or more water-soluble compounds selected from polyvinyl alcohol, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide.
MMM. The method of any one of the previous sentences wherein the mixture comprises less than 1% water-soluble synthetic polymers, based on the weight of the mixture. NNN. The method of any one of the previous sentences wherein the mixture is substantially free of water-soluble synthetic polymers.
OOO. The method of any one of the previous sentences wherein the oriented tube has a burst pressure of at least any of the following: 4, 5, 6, 7, 8, 10, 12, and 14 psig.
PPP. The method of any one of the previous sentences wherein the oriented tube has a water transmission rate for an 8 hour hang time of at least any of 24, 28, 30, 35, 40, 50, 80, 100, 120, and 150 g/m2/hr and/or at most any of 24, 28, 30, 35, 40, 50, 80, 100, 120, and 150 g/m2/hr.
QQQ. The method of any one of the previous sentences wherein the oriented tube has a wall thickness of at least any of 20, 30, 40, 50, 80, 100, 150, and 200 microns.
RRR. The method of any one of the previous sentences wherein the oriented tube is monolayer.
SSS. The method of any one of the previous sentences wherein the cellulose fiber has an average fiber length of at least any of 10, 20, 30, 50, 75, 90, 100, 125, 150, 175, 200, 225, and 250 microns.
TTT. The method of any one of the previous sentences wherein the mixture comprises at least any of 10, 12, 15, 18, 20, 22, 25, 28, 30, 32, 35, 38, 40, 42, and 45% cellulose fiber.
UUU. The method of any one of the previous sentences wherein the mixture comprises at least any of 50, 60, 70, 80, and 85% of nylon-6 content, based on the weight of the mixture.
VVV. The method of any one of the previous sentences wherein the mixture comprises at most any of 55, 60, 70, 80, and 90% of nylon-6 content, based on the weight of the mixture.
WWW. The method of any one of the previous sentences wherein the extruding step comprises extruding with a twin screw extruder.
XXX. The method of any one of the previous sentences wherein the extruding step does not use extensional flow mixing.
YYY. A food casing made by the method of any one of the previous sentences.

### EXAMPLES

The following examples are presented for the purpose of further illustrating and explaining one or more embodiments of the present invention and are not to be taken as limiting in any regard. Unless otherwise indicated, all parts and percentages are by weight. In the examples below, these abbreviations have the following meanings:

“PA6-40” is a nylon-6 (polyamide-6 or “poly(caprolactam)”) available from BASF Corporation under the Ultramid B40 trade name and has a melting temperature of 220° C., a relative viscosity of about 4.0 (1% [m/v] in 96% [m/m] sulfuric acid (ISO 307 Huggins method)), and a viscosity number of about 250 ml/g (0.5% [m/v] in 96% [m/m] sulfuric acid (ISO 307)), according to manufacturer's data. PA6-40 is non-nucleated, non-lubricated, having a natural color.

“PA6-27” is a nylon-6 (polyamide-6 or “poly(caprolactam)”) available from BASF Corporation under the Ultramid B27E-01 trade name and has a melting temperature of 220° C. and a relative viscosity of about 2.7 (1% [m/v] in 96% [m/m] sulfuric acid (ISO 307 Huggins method)) and a viscosity number of about 150 ml/g (0.5% [m/v] in 96% [m/m] sulfuric acid (ISO 307)), according to manufacturer's data. PA6-27 is non-nucleated, non-lubricated, having a natural color.

“Cellulose-1” is cellulose fiber available from CreaFill Fibers Company (Chestertown, Md.) under the CreaClear CC200LS (or TC 200D) trade name and having an average fiber length of 155 micron, an average individual fiber thickness of 1 to 2 micron, and a char point of 180° C., according to manufacture's data.

“Talc” is magnesium silicate nucleating and processing aid HTP Ultra 5L Talc (CAS 14807-96-6) in final composite supplied by IMI Fabi.

“CalcCarb” is calcium carbonate processing aid Triton 20T Calcium Carbonate, supplied by OMYA GmbH (manufactured by Mühlendorfer Kreidefabrik, Vienna Austria) (CAS 1317-65-3).

“CalcStear” is calcium stearate processing aid STE FN VEG supplied by Chemtura.

Seamless blown film tube Examples 1 and 2 that are useful as food casings were produced as follows.

Cellulose-1 was dried for 18 hours in an oven at an oven temperature of 80 C having a dried nitrogen ambient environment. The dried Cellulose-1 was tumble blended with the Talc, CalcCarb, and CalcStear processing aids to form Cellulose/Processing Aid Blends A and B having the following compositions:

Cellulose/Processing Aid Blends

| | Blend A | Blend B |
|---|---|---|
| Cellulose-1 | 91.36 wt % | 91.25 wt % |
| Talc | 3.44 wt % | 3.49 wt % |
| CalcCarb | 2.60 wt % | 2.63 wt % |
| CalcStear | 2.60 wt % | 2.63 wt % |

PA6-27 and PA6-40 were pre-blended at a weight ratio of 9 to 1 and dried in an oven at an oven temperature of 80° C. in desiccated air for 8 hours. The dried PA6-27/PA6-40 blend was fed into an extruder via gravimetric feeder. The cellulose/processing aid blend was fed into the extruder via a gravimetric feeder and a side feeder. The extruder was a 12 barrel ZSK-30 Twin-Screw extruder from Coperion, equipped with a side feeder at Barrel 8.

Mixtures A and B were formed by mixing the PA6-27/PA6-40 blend with Cellulose/Processing Aid Blend A and B, respectively, to have the compositions below.

| | Mixture A | Mixture B |
|---|---|---|
| PA6-27 | 77.18 wt % | 73.23 wt % |
| PA6-40 | 8.58 wt % | 8.14 wt % |
| Cellulose-1 | 13.0 wt % | 17.0 wt % |
| Talc | 0.50 wt % | 0.65 wt % |
| CalcCarb | 0.37 wt % | 0.49 wt % |
| CalcStear | 0.37 wt % | 0.49 wt % |

Mixture A had a nylon-6 content of 85.76% (77.18+8.58), and Mixture B had a nylon-6 content of 81.38% (73.24+8.14), based on the weight of the mixture. For each of Mixtures A and B, the nylon-6 content had a PA6-27 grade content of 90% based on the weight of the total nylon-6 content and a PA6-40 grade content of 10% based on the weight of the total nylon-6 content. Accordingly, the weighted average viscosity number of the nylon-6 content in each of Mixtures A and B was about 160 ml/g, which was calculated by (150 ml/g)(0.9)+(250 ml/g)(0.1).

Mixture A was extruded and strand-pelletized under the following process conditions: throughput was 25 kg/hr; the exit die was 4 hole strand die at 0.16 inch hole diameter; die backpressure was 160 psi; screw RPM was 400; motor torque was 75% of full load (15 HP motor); screw profile was a conventional system normally used in wood-plastic composite processing designed for vacuum venting at barrel 10 and side feeding at barrel 8; melt exit temperature of 225° C. The strands were air quenched on a conventional belt conveyor, and cut into pellets.

Mixture B was extruded and strand-pelletized under the same processing conditions, except that the motor torque was 68% of full load.

The resulting Mixture A and B pellets were dried for 8 hours in a desiccant air dryer having an 80° C. temperature.

The dried pellets for Mixture A were converted into seamless, blown-film casing tube A using the following procedure. Mixture A pellets were fed into an extruder. The extruder was a 10 barrel ZSK-30 twin-screw extruder from Coperion, equipped with a gravimetric feeder; a Maag gear pump at the extruder exit set up to maintain 190 psi at the inlet and 1830 psi at the exit, and a spiral mandrel blown film die/air ring (1 inch die diameter, 0.030 inch gap), supplied by Future Design. The extruder was operated under the following conditions: throughput 24.6 lbs/hr; rpm of 89; die backpressure 1830 psi; die temperature 223C; blow up ratio of 1.6. The Saturn Air Ring had conventional chilled air use. The line speed was 31 fpm at the winder. The twin screw extruder was not vented. The upper nip rolls were 53 inches above the die. The flattened casing tube A exited the upper nip rolls and was wound into a reel using a conventional winder.

The dried pellets for Mixture B were converted into seamless, blown-film casing tube B using the same procedure and equipment as above, except as noted here. The Maag gear pump at the extruder exit was set up to maintain 270 psi at the inlet and 2586 psi at the exit. The extruder was operated under the following conditions: throughput 35.2 lbs/hr; die backpressure 2586 psi; blow up ratio of 2.0. The line speed was 44.5 fpm at the winder. The flattened casing tube B exited the upper nip rolls and was wound into a reel using a conventional winder.

The resulting extruded seamless Tubes A and B in the configuration of a flattened film were tested, before any orientation step, with the following results.

| | Extruded Tube A | Extruded Tube B |
|---|---|---|
| Apparent density (g/cm³) | 0.80 | 0.76 |
| Thickness (microns) | 187 | 158 |
| Flatwidth (mm ± 1 mm) | 64 | 79 |
| Gauge (grams/meter length) | 19.3 | 18.9 |
| Burst pressure (psig) | 23 | 14.5 |

Apparent density, thickness, and area measurements are according to ASTM D2346, ASTM D1813, and ASTM D2347, respectively, except as applied to a film rather than leather, measuring the dimensions and weight for a 7 inch length of film material.

To conduct stretch-burst testing, samples of non-oriented extruded seamless Tubes A and B were soaked for 10 minutes in room temperature water to simulate conditions of use for casings. One end of the tube was sealed to the pressure source and the other end was sealed around a rubber plug equipped with a pressure gauge. The sample length was 18 inches, which after clamping and sealing for the testing apparatus, provided about 16 inches actual test length. Compressed air was slowly introduced so that the casing ruptured in approximately 1 minute. The diameter and pressure readings were taken manually at various pressure increments. The burst pressure of the non-oriented extruded seamless Tubes A and B were 23 psig and 14.5 psig, respectively.

The extruded seamless Tubes A and B were oriented to form Examples 1 and 2, respectively, as follows. Samples of each of Tubes A and B were cut into 10 inch lengths, and immersed in 90° C. water for 3 minutes before stretching, then stretched in the machine direction by 50% to a stretched length of 15 inches at a rate of 0.5 inches per minute while fully immersed in 90° C. water. The resulting Examples 1 and 2 oriented seamless tubes were removed from the water and air dried for one minute.

The resulting Example 1 and Example 2 oriented seamless tube were tested with the following results:

| | Example 1 | Example 2 |
|---|---|---|
| Apparent density (g/cm³) | 0.79 | 0.74 |
| Thickness (microns) | 179 | 144 |
| Flatwidth (mm ± 1 mm) | 61 | 74 |
| Gauge (grams/meter length) | 16.5 | 15.7 |
| Burst pressure (psig) | 14.5 | 8 |
| Water Transmission Rate | 29 | 82 |
| (g/m²/hr) | | |
| Calculated Specific density | 1.165 | 1.177 |
| (g/cm³) | | |
| Voids | 32.2% | 37.1% |

Apparent density, thickness, and area measurements are according to ASTM D2346, ASTM D1813, and ASTM D2347, respectively, except as applied to a film rather than leather, measuring the dimensions and weight for a 7 inch length of film material.

The void content was calculated by subtracting from 100% the ratio (%) of the apparent density to the calculated specific density, namely, for Example 1 tube 100%−(0.79÷1.165)(100)=32.2% voids; for Example 2 tube, 100%−(0.74÷1.177)(100)=37.1% voids.

The calculated specific density of 1.165 g/cm3 and 1.177 g/cm3 for Examples 1 and 2 tubes, respectively, were determined by multiplying the density of each component in the tube by its fractional weight in the tube. The following component density values were used:

| | Density | Example 1 | Example 2 |
|---|---|---|---|
| Component | (g/cm3) | (wt. %) | (wt. %) |
| Cellulose-1 | 1.30 | 13.0 | 17.0 |
| PA6-27; PA6-40 | 1.13 | 85.76 | 81.37 |
| CalcStear | 1.12 | 0.37 | 0.49 |
| CalcCarb | 2.7 | 0.37 | 0.49 |
| Talc | 2.7 | 0.49 | 0.65 |

The Water Transmission Rate (WTR) for Example 1 tube was measured by heat sealing closed the bottom end of the tube sample, filling the tube with water to a column height of 28.8 cm length, heat sealing closed the top end of the tube sample, hanging the filled casing for 7 V2 hours in a 23° C. ambient environment, and measuring the weight loss (no external pressure force applied). The initial weight of water was 272.3 grams, and the final weight was 265.3 grams, for a weight loss of 0.33% per hour. The weight loss water was divided by the internal surface area of the casing originally wetted by the water fill, and also divided by the hang time, to calculate the WTR.

The WTR for Example 2 tube was measured similarly, but with a filled water column height of 23 cm length, hanging time of 7 hours. The initial weight of water was 344.6 grams, and final weight was 325 grams, for a weight loss of 0.8% per hour.

The stretch-burst test measurements for the Examples 1 and 2 oriented seamless tubes were measured under the same conditions and preparation as the Tubes A and B discussed above, with results of:

| | Example 1 | Example 2 |
|---|---|---|
| Inflation Pressure (psig) | Tube Diameter (mm) | Tube Diameter (mm) |
| 1 | 39.7 | 50.0 |
| 2 | 39.8 | 50.2 |
| 3 | 39.9 | 51.0 |
| 4 | 40.2 | 51.8 |
| 5 | 40.3 | 53.3 |
| 6 | 40.5 | 57.2 |
| 7 | 40.7 | — |
| 8 | — | burst |
| 14.5 | burst | — |

The initial diameter is the diameter at 1 psig inflation level. The Example 1 casing tube expanded by 1.2% from its initial diameter to its diameter at the 4 psig inflation amount, indicating a very strong, rigid product. The Example 2 casing tube expanded by 3.6% from its initial diameter to its diameter at the 4 psig inflation amount (4 psig is a typical pressure when stuffing a casing with food product). This is sufficiently rigid to function in slicing applications.

Both the Example 1 and 2 casings were relatively “stiff,” and uniform like a pipe, despite no transverse-direction orientation post-initial bubble extrusion. Such characteristics are desirable for a casing enclosing, for example, sausage product because they enhance portion and slicing control.

Hunter colorimeter tests were performed on the Examples 1 and 2 oriented tubes, with values of:

| Example 1 | Example 2 |
|---|---|
| L* = 84.1 to 84.8 (black-white); | L* = 85.1 to 85.2 (back-white) |
| a* = 0.76 to 0.77 (green-red); | a* = .77 to 0.80 (green-red) |
| b* = 13.65 to 14.09 (blue-red). | b* = 13.44 to 13.61 (blue-yellow) |

These results indicate a very white color (where L is very high), with a slight yellow color appears ivory color to the eye. This indicates very low cellulose degradation.

Any numerical value ranges recited herein include all values from the lower value to the upper value in increments of one unit provided that there is a separation of at least 2 units between any lower value and any higher value. As an example, if it is stated that the amount of a component or a value of a process variable (e.g., temperature, pressure, time) may range from any of 1 to 90, 20 to 80, or 30 to 70, or be any of at least 1, 20, or 30 and/or at most 90, 80, or 70, then it is intended that values such as 15 to 85, 22 to 68, 43 to 51, and 30 to 32, as well as at least 15, at least 22, and at most 32, are expressly enumerated in this specification. For values that are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The above descriptions describe various embodiments of the invention. Various alterations and changes can be made without departing from the spirit and broader aspects of the invention as defined in the claims, which are to be interpreted in accordance with the principles of patent law, including the doctrine of equivalents. Except in the claims and the specific examples, or where otherwise expressly indicated, all numerical quantities in this description indicating amounts of material, reaction conditions, use conditions, molecular weights, and/or number of carbon atoms, and the like, are to be understood as modified by the word “about” in describing the broadest scope of the invention. Any reference to an item in the disclosure or to an element in the claim in the singular using the articles “a,” “an,” “the,” or “said” is not to be construed as limiting the item or element to the singular unless expressly so stated. The definitions and disclosures set forth in the present Application control over any inconsistent definitions and disclosures that may exist in an incorporated reference. All references to ASTM and ISO test standards are to the most recent, currently approved, and published version of the ASTM or ISO test identified, as of the priority filing date of this application. Each such published ASTM and ISO test method is incorporated herein in its entirety by this reference.

What is claimed is:

1. A method of making a food casing comprising:
extruding a mixture to form a seamless tube, the mixture comprising:
at least 10% of cellulose fiber based on the weight of the mixture; and
at least 50% of nylon-6 content based on the weight of the mixture, wherein the nylon-6 content has a weighted average viscosity number of at least 155 ml/g and at most 230 ml/g; and
orienting the seamless tube by at least 10% in the machine direction with at most 0% orientation in the transverse direction to form an oriented seamless tube.

2. The method of claim 1 wherein the orienting step orients the seamless tube by at least 25% in the machine direction.

3. The method of claim 1 wherein the orienting step provides the oriented seamless tube having at least 20% voids.

4. The method of claim 1 wherein the orienting step increases the void content of the seamless tube by at least 2 percentage points.

5. The method of claim 1 wherein the orienting step occurs while submerging the seamless tube under water.

6. The method of claim 5 wherein the oriented seamless tube is subsequently dried to increase the void content by at least 2 percentage points.

7. The method of claim 1 wherein the nylon-6 content has a weighted average viscosity number of at most 220 ml/g.

8. The method of claim 1 wherein the nylon-6 content has a weighted average viscosity number of at most 180 ml/g.

9. The method of claim 1 wherein the nylon-6 content has a weighted average viscosity number of at least 170 ml/g.

10. The method of claim 1 wherein the mixture comprises:
at least 50%, based on the weight of the mixture, of one or more nylon-6 grades having a viscosity number of less than 165 ml/g; and
at least 5%, based on the weight of the mixture, of one or more nylon-6 grades having a viscosity number of at least 165 ml/g.

11. The method of claim 10 wherein the mixture comprises at least 60%, based on the weight of the mixture, of the one or more nylon-6 grades having a viscosity number of less than 165 ml/g.

12. The method of claim 11 wherein the mixture comprises at most 15%, based on the weight of the mixture, of the one or more nylon-6 grades having a viscosity number of at least 165 ml/g.

13. The method of claim 1 wherein the mixture comprises less than 1%, by weight of the mixture, of one or more water-soluble compounds selected from polyvinyl alcohol, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide.

14. The method of claim 13 wherein the mixture is substantially free of water-soluble compounds selected from one or more water-soluble compounds selected from polyvinyl alcohol, poly(alkylene glycols), polyvinylpyrrolidone, copolymers of vinylpyrrolidone with at least one alpha, beta-olefinically unsaturated monomer building block, (co)polymers of acrylic acid, and (co)polymers of acrylamide.

15. The method of claim 13 wherein the mixture comprises less than 1% water-soluble synthetic polymers, based on the weight of the mixture.

16. The method of claim 1 wherein the oriented seamless tube has a burst pressure of at least 8 psig.

17. The method of claim 1 wherein the oriented seamless tube has a water transmission rate of at least 24 grams/m2/hour for an 8 hour hang time.

18. The method of claim 1 where the oriented seamless tube has a wall thickness of at least 20 microns.

19. The method of claim 1 wherein the oriented seamless tube is monolayer.

20. The method of claim 1 wherein the cellulose fiber has an average fiber length of at least 100 microns.

21. The method of claim 1 wherein the mixture comprises at least 18% cellulose fiber.

22. The method of claim 1 wherein the mixture comprises at least 70% of nylon-6 content based on the weight of the mixture.

23. The method of claim 1 wherein the extruding step comprises extruding with a twin screw extruder.

24. The method of claim 1 wherein the extruding step does not use extensional flow mixing.

25. A food casing made by the method of claim 1.
